(19) United States
(12) Patent Application Publication
(10) Pub. No.: US 2017/0330457 A1
(43) Pub. Date: Nov. 16, 2017

(54) TECHNIQUES FOR VEHICLE BASED MESSAGE TRANSMISSION AND RECEPTION

(71) Applicant: ZTE Corporation, Shenzhen (CN)

(72) Inventor: Rajesh Bhalla, Gahanna, OH (US)

(21) Appl. No.: 15/592,163

(22) Filed: May 10, 2017

Related U.S. Application Data
(60) Provisional application No. 62/334,007, filed on May 10, 2016.
(60) Provisional application No. 62/337,567, filed on May 17, 2016.

(51) Int. Cl. G08G 1/0967; G08G 1/09; H04W 4/06; H04W 72/04; H04W 92/18

(52) U.S. Cl. CPC G08G 1/0967; H04W 4/06; H04W 72/0413; G08G 1/091; G08G 1/096783; H04W 92/18

(57) ABSTRACT

Techniques for vehicle based data transmission and reception using network-based infrastructure such as a road-side unit. Vehicle messages are filtered and forwarded to reduce latency, and at the same time manage long distance reach of the messages. In one example embodiment, an LTE uplink may be used to carry vehicle-generated messages to the network.

### CROSS REFERENCE TO RELATED APPLICATIONS

This patent document claims the benefit of priority of U.S. Provisional Patent Application No. 62/334,007, filed on May 10, 2016, and U.S. Provisional Patent Application No. 62/337,567, filed on May 17, 2016. The entire contents of the before-mentioned patent applications are incorporated by reference as part of the disclosure of this document.

### BACKGROUND

This patent document relates to wireless communications.

Data traffic that originates from or terminates at a vehicle is becoming more and more attractive for realizing new applications such as self-navigating vehicles, and others. Vehicle speeds, and reaction times of other systems involved in the communication, e.g., a human user, could put stringent latency requirement of such vehicle based data traffic.

### SUMMARY

This patent document describes technologies for, among other things, operating a wireless network that provides architectural support for receiving data communication from vehicles, distributing the data communication in a latency-efficient manner to network devices, and propagating the messages to the desired end points.

In one example aspect, a method of wireless communication is implemented at network-side of a wireless communication network to include establishing a logical communication connection with user equipment (UEs) in vehicles; receiving a message on the logical connection from a first UE; filtering the message to determine a localization area to which the message should be distributed; distributing the message according to the determination to the UEs such as RSUs within the localization area using a permanently established SIPTO connection with the UEs.

In some implementations, this message may be a V2X message. In some implementations, receiving the message comprises receiving the message on an uplink channel at an eNodeB of a long term evolution (LTE) network. In some implementations, receiving the message comprises receiving the message on an uplink channel at a road-side unit (RSU) of a long term evolution (LTE) network. In some implementations, receiving the message comprises receiving the message via the SIPTO connection or PC5 interface. In some implementations, the message is originally transferred from a second UE to the first UE over PC5 interface before the receiving of the message. In some implementations, the first UE is equipped in the a vehicle and the second UE is located at a road-side unit (RSU). In some implementations, distributing the message includes distributing the message to the first UE. In some implementations, the filtering the message is performed at a RSU or a V2X application server.

In another aspect, a wireless communication system for providing operational support to vehicular data reception and transmission is provided to comprise: a module that establishes a logical communication connection with user equipment (UEs) in vehicles; a module that receives a message on communication connection from a first UE; a module that filters the message to determine a localization area to which the message should be distributed; and a module that distributes the message according to the UEs in the localization area via a permanently established selected internet protocol traffic offload (SIPTO) connection with the UEs.

In some implementations, the module for receiving includes an eNodeB of a long term evolution (LTE) network. In some implementations, the module for receiving the message comprises a road-side unit (RSU) of a long term evolution (LTE) network. In some implementations, the module for receiving the message operates to receive the message via the SIPTO connection or PC5 interface. In some implementations, the message is originally transferred from a second UE to the first UE over PC5 interface before the receiving of the message. In some implementations, the first UE is equipped in the a vehicle and the second UE is located at a road-side unit (RSU). In some implementations, the module that distributes the message operates to distribute the message to the first UE. In some implementations, the filtering the message is performed at s RSU or a V2X application server.

Details of the above aspects and their implementations, and other features, are set forth in the accompanying drawings, the description and the claims.

### BRIEF DESCRIPTION OF THE DRAWINGS

FIG. 1 shows an example method of wireless communication.

FIG. 2 shows an example wireless communication system.

FIG. 3 shows an exemplary implementation of V2X message transmission/reception for V2X Services using RSU with PC5.

FIG. 4 shows an exemplary implementation of V2X message transmission/reception on downlink using UE Type RSU with LTE-Uu and PC5.

FIG. 5 shows an exemplary architecture model for V2X message transmission/reception on downlink using UE Type RSU with LTE-Uu and PC5.

FIG. 6 shows an implementation of V2X message transmission/reception on downlink using UE Type RSU with LTE-Uu and PC5.

FIG. 7 shows another implementation of a V2X message transmission/reception on downlink using UE Type RSU with LTE-Uu and PC5.

FIG. 8 shows a V2X message transmission/reception on uplink using UE Type RSU with LTE-Uu and PC5.

FIG. 9 shows an architecture model for V2X message transmission/reception on uplink using UE Type RSU with LTE-Uu and PC5.

FIG. 10 shows a V2X message transmission/reception on uplink for V2X Services using RSU with PC5 and LTE-Uu.

### DETAILED DESCRIPTION

This document describes techniques, mechanisms, devices, and systems for vehicle to vehicle (V2V) vehicle to pedestrian (V2P), Vehicle to Infrastructure (V2I) and other communications, sometimes collectively called V2X communication.

Fast moving vehicles that may have up to 280 kilometers per hour relative speed may make it hard to use direct communication between user equipment (UE) using well-known protocols such as ProSe (proximity service). One possible solution to alleviate this problem is to deploy one or more road side units (RSU) that can wirelessly communicate with network infrastructure and vehicles and other UE.

Furthermore, when network uplink is used for transmitting V2X message from a vehicle, the delay involved in processing through traditional network equipment such as eNB and gateways, may be prohibitively large and may generate too many messages in a coverage area. One solution presented herein is to use a V2X message offload (VMO) that is able to recognize and filter a V2X message and route it to RSUs in a localized area using a permanently established SIPTO connection. This architecture leads to low-latency and localized communication of V2X messages.

This patent document provides techniques that can be used by wireless devices for V2X communication in a wireless network. In the following, various implementations have been discussed for V2X services using, for example, UE type RSU with LTE-Uu and PC5 one-to-all broadcast. In some implementations, the suggested implementations do not use eMBMS for downlink broadcast. V2X applications contain the following four types of messages:

1. Vehicle-to-Vehicle (V2V): V2V applications on the UEs expect to exchange V2V application information with V2V applications on other UEs that are in proximity. V2V messages contain V2V application information e.g. location, dynamics and attributes. 3GPP transport of V2V messages is predominantly broadcast-based. Such 3GPP transport includes the transport between UEs directly and/or due to the limited direct communication range, the transport between UEs via infrastructure supporting V2X communication e.g. RSU, application server etc.

2. Vehicle-to-Pedestrian (V2P): V2P applications expect UEs that are in proximity of each other to exchange V2P application information. 3GPP transport of V2P messages includes the transport between UEs directly and/or due to the limited direct communication range, the transport between UEs via infrastructure supporting V2X communication, e.g. RSU, application server etc.

3. Vehicle-to-Infrastructure (V2I): The UE supporting V2I applications transmits messages containing V2I application information to an RSU. The RSU transmits V2I messages to one or more UEs supporting V2I applications.

4. Vehicle-to-Network (N2N): The UE supporting V2N applications communicates with an application server supporting V2N applications. Both parties communicate with each other via EPS.

From the characteristics of V2V/V2P type V2X messages, it is observed that V2V/V2P messages are exchanged between UEs that are in proximity of each other, 3GPP transport of V2V/V2P messages is predominantly broadcast-based, 3GPP transport of V2V/V2P messages can be between UEs directly, and/or due to the limited direct communication range, the transport between UEs can be via RSU, Application Server etc. V2I/V2N message communication is via an RSU. The RSU transmits such messages to one or more UEs that support such V2I/V2N applications.

There are requirements in TS 23.185 that 3GPP network be capable of transferring messages between UEs supporting V2V/V2P/V2I services, directly or via an RSU, with a maximum latency of 100 ms. There are also requirements that the 3GPP network shall be able to provide a communication range for such messages so as to give the driver(s) ample response time (e.g., 4 sections) for maximum relative velocity of UEs up to 280 km/h. The V2X capable UEs could generate a maximum frequency of 10 messages per second per UE. V2X message broadcast communication range needs to be sufficient to meet latency, speed and range requirements. Considering that up to 10 V2X messages per second can be generated per UE, broadcast communication range should not be very large either so as to cause message congestion in the network and at the UEs.

There are also requirements for the need to dynamically manage the target communication range of the V2X messages. For example, the target communication range for V2X messages can change dynamically depending on factors such as the type of the V2X UE (e.g. emergency vehicle), nature of the message (e.g. safety related or not safety related), speed of the vehicle, environmental factors etc. It could be possible to derive such information from the information in the V2X messages e.g. location, dynamics, attributes etc. V2X Application Server(s) could be able to determine the target communication area for V2X messages e.g. from the information within the message or from other service layer information.

Some implementations discussed in this patent document are proposed to follow the basis of operation for normative work as specified in TS 23.785. Such operations, however, are provided as one example only and it is still possible to operate in different manners. For the understanding of the exemplary operations, the relevant requirements in TS 23.785 that are pertinent to the discussions here are reproduced below:

1. Examples of Service Specific Requirements:

[R-5.1-003] A UE supporting V2X application shall be able to transmit and receive messages when served or not served by E-UTRAN supporting V2X communication.

[R-5.1-004] An RSU shall be able to transmit/receive messages to/from a UE supporting V2X application.

[R-5.1-011] The 3GPP system shall be able to provide means for an application server and the RSU to control the area and the size of the area where the messages are being distributed.

[R-5.2.1-001] The E-UTRA(N) shall be capable of transferring messages between two UEs supporting V2V/P application, directly or via an RSU, with a maximum latency of 100 ms.

[R-5.2.1-003] The E-UTRA(N) shall be capable of transferring messages between a UE supporting V2I application and an RSU with a maximum latency of 100 ms.

[R-5.2.1-004] The E-UTRAN shall be capable of transferring messages via 3GPP network entities between a UE and an application server both supporting V2N application with an end-to-end delay no longer than 1000 ms.

[R-5.2.3-001] The E-UTRA(N) shall be able to support a maximum frequency of 10 messages per second per UE or per RSU.

2. Examples of Speed and Range Requirements:

[R-5.2.4-001] The E-UTRAN shall be capable of supporting a communication range sufficient to give the driver(s) ample response time (e.g. 4 seconds).

[R-5.2.5-001] The 3GPP system shall be capable of transferring messages between UEs supporting V2V application, while the maximum relative velocity of the UEs is 280 km/h, regardless of whether the UE(s) are served or not served by E-UTRAN supporting V2X communication.

[R-5.2.5-002] The 3GPP system shall be capable of transferring messages between UEs supporting V2V and V2P application, respectively, while the UE's maximum absolute velocity is 160 km/h, regardless of whether the UE(s) are served or not served by E-UTRAN supporting V2X communication.

From the characteristics of V2V/V2P type V2X messages, the target DL broadcast area of a V2V/V2P/V2I message is an area in the proximity of the V2X UE that originated the message. Considering the requirements for communication range sufficient to give at least 4 seconds response time at maximum relative velocity of 280 Km/h translates to a communication range of approximately 300 meters.

For V2V/V2P messages using broadcast mechanisms, communication range of approximately 300 meters is needed at max relative velocity of 280 km/h. It is likely that PC5 one-to-all ProSe Direct Communication between the V2X UEs will not be able to meet such communication range in many deployment scenarios. Mechanisms that support distribution of V2X messages reliably over the desired communication range are needed. Considering that up to 10 V2X messages per second can be generated per V2X UE, the communication range using broadcast mechanisms should not be very large either. A large number of vehicles (UEs) in a large communication range could generate a very large number of V2X messages. Such messages, in turn, are broadcast to all V2X UEs within the communication range, resulting in a large number of messages that need to be processed by the receiving V2X UEs. It is very likely that the receiving V2X UEs (e.g. UEs in vehicles/pedestrians) could get overwhelmed by such large number of messages and miss timely processing of V2V/V2P messages (e.g. security/safety related messages) from V2X UEs that are in proximity because other V2X messages from V2X UEs further away in the communication range are pending ahead in the processing queue.

In light of the characteristics of V2V/V2P type V2X messages, message communication range should be sufficient to meet the speed and range requirements in TS 22.185. At the same time, communication range, especially for broadcast mechanisms should not be very large so as to cause message congestion in the network and at the UEs. The target communication range can change dynamically depending on factors such as the type of the V2X UE (e.g. emergency vehicle), nature of the message (e.g. safety related or not safety related), speed of the vehicle, environmental factors etc. For example for V2X UEs in vehicles with maximum relative velocity of 50 Km/h, e.g. in urban environments, the communication range requirement with 4 seconds response time is approximately 55 meters.

From the characteristics of V2V/V2P type V2X messages, mechanisms are needed to dynamically determine the target communication range of the V2X messages. It is possible to derive such information from the information in the V2X messages e.g. location, dynamics, attributes etc. V2X Application Server(s) could be able to determine the target communication area for V2X messages e.g. from the information within the message or from other service layer information. Some implementations of the disclosed technology address issues including V2X message transmission/reception for V2V Service and V2P Service and V2X message transmission/reception between a vehicle and an RSU for V2I. Some implementations of the disclosed technology also discuss issues on latency improvements without the use of eMBMS though.

V2V/V2P messages are exchanged between V2X UEs that are in proximity of each other predominantly using broadcast-based mechanisms. V2X UEs can use such broadcast based mechanisms for exchanging V2I messages with the RSUs also. A method of broadcast-based messaging between V2X UEs/RSUs that are in close proximity is to use PC5 based one-to-all ProSe Direct Communication. PC5 based one-to-all ProSe Direct Communication could have the limitation of communication range for transporting V2X messages reliably in certain scenarios. For example, UEs such as the those used by the pedestrians for V2P services may have lower battery capacity, limited radio sensitivity etc., hence may be able to receive communication from V2X UEs that are not in very close proximity. V2X UEs may not dynamically manage PC5 based one-to-all ProSe Direct Communication area based on factors such as the type of the V2X UE (e.g. emergency vehicle), the nature of the V2X message (e.g. safety related or not safety related), the speed of the V2X UE, environmental factors. So, there is also a need to dynamically manage the communication area of PC5 based one-to-all ProSe Direct Communication based on certain factors. The disclosed technology provides some implementations which uses UE type RSUs (RSUs implemented as stationary UEs) that are deployed to provide adequate coverage to vehicular traffic infrastructure e.g. along urban roadsides, on highways etc. Some implementations in the following clauses describe methods for the delivery of V2X messages for V2X services in the desired communication range.

Examples of Implementations

V2X message transmission and reception for V2X services using UE Type RSU with PC5 is discussed below.

In this implementation V2X UEs and UE type RSUs (RSUs implemented as stationary UEs) use PC5 one-to-all ProSe Direct Communication for the transmission and reception of V2X messages. The implementation can be supported using the existing procedures over PC5 and the requirements on V2X UEs is to be able to communicate over PC5. The RSUs receive V2X messages over PC5. V2X Application at the RSUs processes the V2X message locally to determine the area and the size of the area where the V2X messages need to be distributed to meet e.g. the range and speed requirements. The RSUs may coordinate and communicate with neighbor RSUs also (e.g. over local networks) for determining the distribution area and for distributing V2X messages over the target distribution area. The RSUs are built to be robust (compared to typical UEs), with sufficient radio sensitivity so as to be able to broadcast V2X messages over PC5 reliably in the designated communication range. The RSUs may also collect and aggregate knowledge of their local environment (e.g. information received from other vehicles, sensor equipment in proximity, surveillance etc.) to provide intelligent V2X services. Such environmental information can be included with the V2X messages broadcasted by the RSUs.

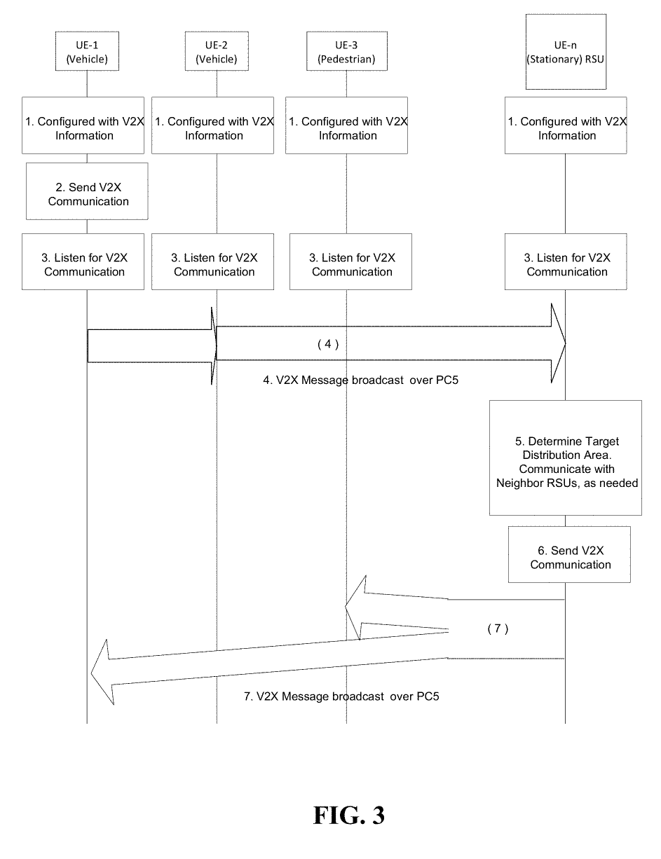

FIG. 3 shows an exemplary implementation of V2X message transmission/reception for V2X Services using RSU with PC5. As illustrated in FIG. 3, the RSU is implemented as a stationary UE-n and hosts V2X Application and V2X UEs transmit and receive V2X messages using PC5 one-to-all ProSe Direct Communication with other UEs that are in proximity. V2X UEs can receive PC5 one-to-all ProSe Direct Communication from the RSUs also. In FIG. 3, UE-1 sends V2X message using one-to-all ProSe Direct Communication which is received by UE-2 and by the RSU as in step-4. UE-3, however, could not receive the V2X message sent by UE-1 due to not being in the reliable PC5 communication range of UE-1. V2X Application at the RSU determines the target distribution area of the V2X message. Though not illustrated in FIG. 3, the RSU may coordinate and communicate with neighbor RSUs for determining and distributing V2X messages over the target area. The RSU and/or neighbor RSU(s), as applicable, broadcast the V2X message received at step-4 using PC5 one-to-all Prose Direct Communication as shown in step-7. All UEs listening for V2X communication in the target distribution area, including UE-3 receive the V2X message sent by the RSU(s).

The following procedural summaries are made in relation to the procedures as shown in FIG. 3:

Step 1. The UEs and the RSUs are configured with information for one-to-all ProSe Direct Communication or obtain such information via authorization mechanisms.

Step 2. UE-1 accesses radio resources for V2X transmission.

Step 3. All UEs, including UEn (UE type RSU) listen on V2X resources over PC5 for direct reception.

Step 4. UE-1 transmits a V2X message which is received by UE-2 and by UEn (RSU). UE-3, however, does not receive the V2X message sent by UE-1 due to not being in the reliable PC5 communication range of UE-1.

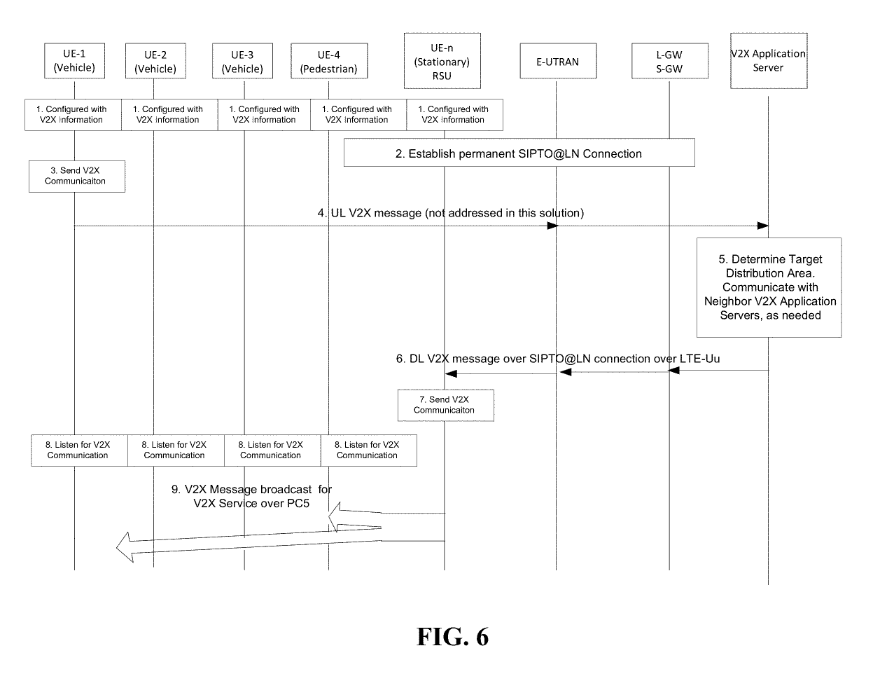

Step 5. V2X Application at the RSU determines the target distribution area of the V2X message. Though not illustrated in FIG. 6.x.3-1, the RSU may coordinate and communicate with neighbor RSUs for determining the target area and distributing V2X messages over the target area. In this implementation, the RSUs communicate with each other over local network. Communication of RSUs over a local network is outside the scope of 3GPP.

Step 6. The RSU and/or neighbor RSU(s) that are in the target distribution area, access radio resources for V2X transmission.

Step 7. The RSU and/or neighbor RSU(s), as applicable, broadcast the V2X message received at step-4 using PC5 one-to-all Prose Direct Communication. All UEs listening for V2X communication in the target distribution area, including UE-3 receive the V2X message sent by the RSU(s).

The implementation discussed for V2X message transmission/reception using UE type RSU with PC5 one-to-all broadcast provides a reliable method that addresses V2X message transmission/reception requirements in TS 22.185 without requiring additional standardization work. This implementation, therefore, can be used as one of the bases for normative work.

Exemplary implementation: V2X message transmission/reception on downlink using UE Type RSU with LTE-Uu and PC5 is discussed below.

This implementation uses UE type RSUs (RSUs implemented as stationary UEs) for downlink one-to-all broadcast of V2X messages over PC5. It may be noted that this implementation does not use eMBMS for downlink broadcast of V2X messages. PC5 one-to-all ProSe Direct Communication between RSUs and UEs is used for downlink transmission/reception of V2X messages. Uplink V2X messages from UEs are received by a V2X Application Server in the operator network over V1 interface. Any of the implementations in this TR for the transmission and routing of V2X messages uplink can be used. Transport of uplink V2X messages are not addressed by this implementation.

This implementation addresses latency reductions and broadcast of VX messages on the downlink only. UE type RSUs (RSUs implemented as stationary UEs) are used for downlink one-to-all broadcast of V2X messages over PC5. EMBMS is not used for downlink broadcast of V2X messages. RSUs implemented as stationary UEs (UE type RSUs) are deployed so as to provide adequate coverage to vehicular traffic infrastructure e.g. along urban roadsides, on highways etc. In order to reduce downlink latency in the operator network, the RSUs maintain a permanent SIPTO@LN PDN connections with L-GWs in the operator network. V2X Application Servers are also located in local network close to vehicular traffic infrastructure.

SIPTO@LN PDN connections support bi-directional unicast also, if required for V2I/V2N services.

On the receipt of an uplink V2X message, the V2X Application Server in operator network processes the message to determine the target area and the size of the area where the V2X message needs to be distributed. The V2X Application Server may coordinate and communicate with other V2X Application Servers for the determination of the target area and distribution of V2X messages in the target area. V2X messages from the V2X Application Server(s) are routed to the RSUs in the target distribution area over the permanent SIPTO@LN connections over LTE-Uu. The RSUs broadcast the received V2X messages over PC5 using one-to-all ProSe Direct Communication. UEs listening for V2X communication in the target distribution area receive V2X messages sent by the V2X Application Server(s) via the RSUs.

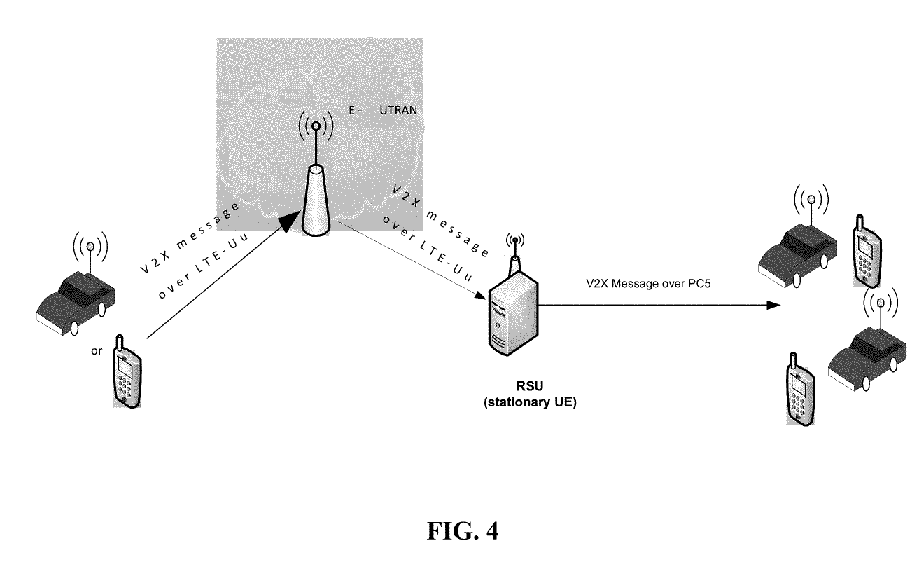

FIG. 4 shows an exemplary implementation of V2X message transmission/reception on downlink using UE Type RSU with LTE-Uu and PC5. In FIG. 4, there are three components illustrated. On the uplink, the UE transmits V2X message to the V2X Application Server over V1 interface. The routing of uplink V2X message from V2X UE to V2X Application Server is not addressed in this implementation. RSUs implemented as stationary UEs are deployed to provide adequate coverage to vehicular traffic infrastructure. In order to reduce latency, each RSU maintains a permanent SIPTO@LN connections with L-GWs in operator network. V2X Application Server is located in local network close to the vehicular traffic infrastructure. V2X Application Server processes uplink V2X messages to determine the target area where the V2X messages need to be distributed. V2X Application Server may coordinate and communicate with other V2X Application Servers also for the determination of target area and the distribution of V2X messages in the target distribution area. V2X Application Server(s) send V2X messages downlink to the RSUs in the target distribution area by routing over permanent SIPTO@LN connections over LTE-Uu. The RSUs broadcast the received V2X messages over PC5 using one-to-all ProSe Direct Communication. UEs listening for V2X communication in the target distribution area receive V2X messages sent by the V2X Application Server(s) via the RSUs.

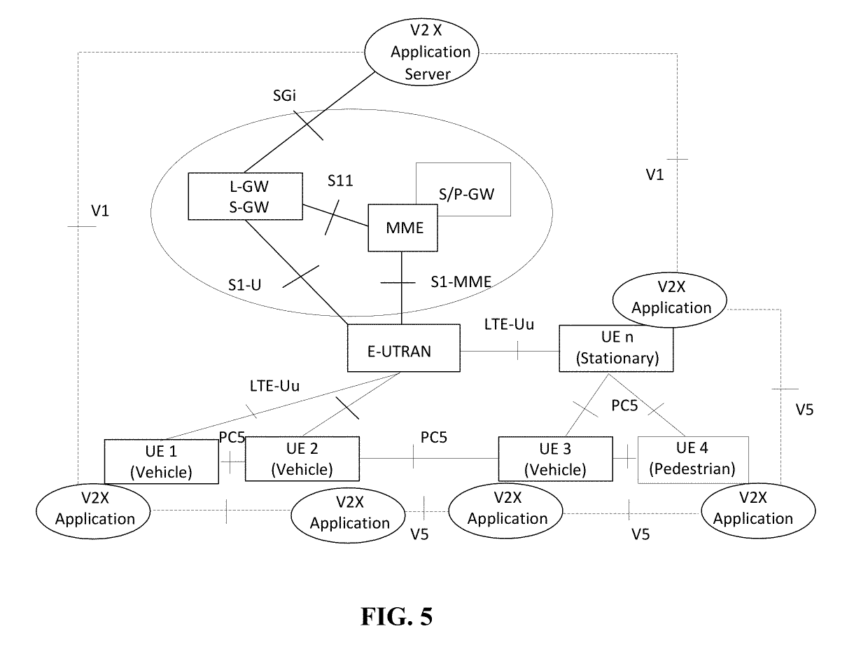

FIG. 5 shows an exemplary architecture model for V2X message transmission/reception on downlink. For SIPTO@LN, stand-alone GW architecture (with S-GW and L-GW collocated) is illustrated. Note that SIPTO@LN with L-GW function collocated with the eNB is not precluded. In FIG. 5, the V2X Application Server can be considered as a V2X Service Layer.

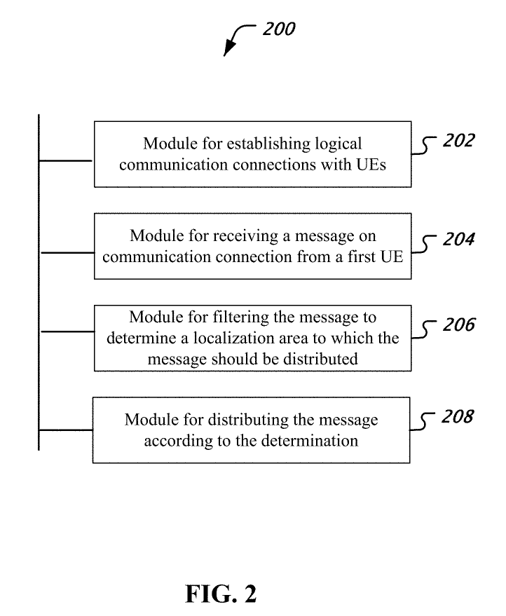

FIG. 6 shows an implementation of a V2X message transmission/reception on downlink using UE Type RSU with LTE-Uu and PC5. As illustrated in FIG. 6, uplink V2X message from vehicle UE-1 is received by V2X Application Server in the operator network over V1 interface as in step-4. The method of transmission and routing of the uplink V2X messages from UE-1 to the V2X Application Server is not addressed by this implementation. The V2X Application Server determines the target distribution area of the V2X message as in step-5. Though not illustrated in FIG. 2.3.2-1, V2X Application Server may coordinate and communicate with other V2X Application Servers for determining the target area and the distribution of V2X messages in the target area. Step-6 shows V2X messages from the V2X Application Server(s) routed to the RSUs in the target distribution area over permanent SIPTO@LN PDN connections over LTE-Uu. At step-9, the RSUs broadcast the received V2X messages over PC5 using one-to-all ProSe Direct Communication. UEs listening for V2X communication on PC5 in the target distribution area receive V2X messages sent by the V2X Application Server via RSUs.

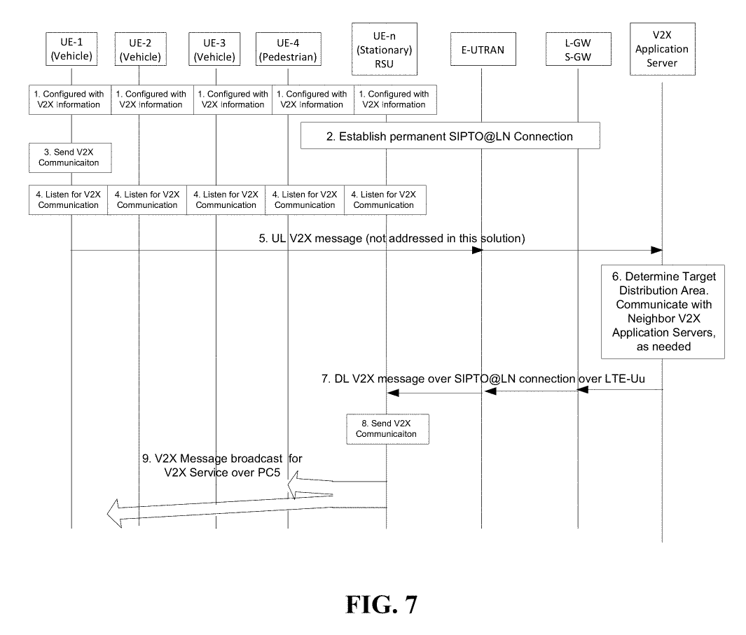

FIG. 7 shows another implementation of a V2X message transmission/reception on downlink using UE Type RSU with LTE-Uu and PC5. The UEs and the RSUs are configured with information for one-to-all ProSe Direct Communication or obtain such information via authorization mechanisms as proposed, for example, in this TR. The RSUs establish permanent SIPTO@LN connection with L-GWs in operator network. As illustrated in FIG. 7, UE-1 transmits V2X Message uplink to V2X Application Server. V2X Application Server(s) determine the target distribution area and forward the V2X message to RSUs in target distribution are for downlink PC5 one-to-all broadcast to V2X UEs.

The following procedural summaries are made in relation to the procedures as shown in FIG. 7:

Step 1. The UEs and the RSUs are configured with information for one-to-all ProSe Direct Communication or obtain such information via authorization mechanisms.

Step 2. The RSUs establish permanent SIPTO@LN PDN connection with L-GWs in operator network.

Step 3. UE-1 accesses radio resources for V2X transmission.

Step 4. All UEs, including UEn (UE type RSU) listen on V2X resources over PC5 for direct reception.

Step 7-5. Uplink V2X message from vehicle UE-1 is received by V2X Application Server in the operator network over V1 interface. The method of transmission and routing of the uplink V2X messages from UE-1 to the V2X Application Server is not addressed by this implementation.

Step 6. V2X Application Server determines the target distribution area of the V2X message. Though not illustrated, the V2X Application Server may coordinate and communicate with other V2X Application Servers for determining the target area and the distribution of V2X messages in the target area.

Step 7. V2X messages from the V2X Application Server(s) are routed to the RSUs in the target distribution area over permanent SIPTO@LN PDN connections over LTE-Uu.

Step 8. The RSUs in the target distribution area access radio resources for V2X transmission.

Step 9. The RSUs broadcast the received V2X messages over PC5 using one-to-all ProSe Direct Communication. UEs listening on PC5 receive V2X messages sent by the V2X Application Server via RSUs.

The implementation of V2X message transmission/reception on the downlink using UE type RSU with SIPTO@LN on LTE-Uu and PC5 one-to-all broadcast provides a reliable method that addresses V2X message transmission/reception requirements in TS 22.185 without requiring additional standardization work. No eMBMS is needed. No additional standardization work on eMBMS is needed. With permanent SIPTO@LN PDN connections with stationary UE type RSUs there are no mobility issues. Thus, this implementation can be used as one of the bases for normative work.

Exemplary implementation: V2X message transmission/reception on uplink using UE Type RSU with LTE-Uu and PC5 is discussed below.

This implementation can be supported using the existing procedures over PC5, and dSIPOTO@LN mechanisms. The requirements on V2X UEs is to be able to communicate over PC5. This implementation uses UE Type RSU (RSUs implemented as stationary UEs) PC5 one-to-all ProSe Direct Communication, and LTE-Uu with E-UTRAN for uplink transmission of V2X messages. This implementation addresses latency reduction on the uplink and does not address latency reductions on the downlink. This implementation may be used in combination with the implementation discussed above for the distribution of V2X messages on the downlink.

RSUs implemented as stationary UEs (UE type RSUs) are deployed so as to provide adequate coverage to vehicular traffic infrastructure e.g. on urban roadsides, on highways etc. In order to reduce uplink latency in the operator network, the RSUs maintain permanent SIPTO@LN PDN connections with L-GWs in the operator network. V2X Application Server is also located in the local network close to vehicular traffic infrastructure. SIPTO@LN PDN connections support bi-directional unicast also, if required for V2I/V2N services.

The RSU receives V2X messages from the V2X UEs over PC5. V2X messages that cannot be processed by the V2X Application(s) locally at the RSU(s) for downlink distribution as in the implementation of V2X message transmission and reception for V2X services using UE Type RSU with PC5; are routed to the V2X Application Server in the operator network over permanent SIPTO@LN connection over LTE-Uu. The V2X Application Server in operator network processes the message to determine the target area and the size of the area where the V2X message needs to be distributed. V2X Application Server may coordinate and communicate with other V2X Application Servers for the determination of the target area and distribution of V2X messages in the target area. How the V2X messages are delivered downlink in the target distribution area is not addressed by this implementation. This implementation may be used in combination with the implementation above discussed for the distribution of V2X messages on the downlink.

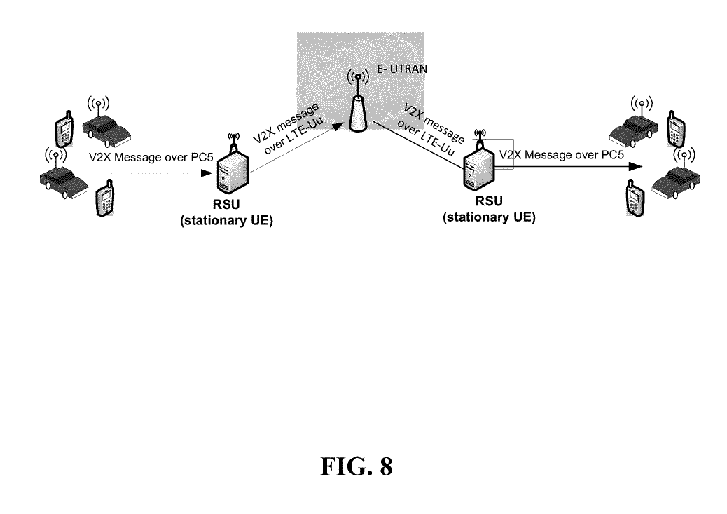

FIG. 8 shows an exemplary implementation of V2X message transmission/reception on uplink using UE Type RSU with LTE-Uu and PC5. There are three components to this implementation as illustrated in FIG. 7. First, RSUs implemented as stationary UEs are deployed to provide adequate coverage to vehicular traffic infrastructure. In order to reduce latency, the RSUs maintain permanent SIPTO@LN connections with L-GWs in operator network. The RSU receives V2X messages from V2X UEs over PC5. V2X messages that cannot be processed by the V2X Application(s) locally in the RSU(s) for downlink distribution are routed to the V2X Application Server in the operator network over permanent SIPTO@LN connection over LTE-Uu. The V2X Application Server in operator network processes the message to determine the target area and the size of the area where the V2X message needs to be distributed. V2X Application Server may coordinate and communicate with other V2X Application Servers for the determination of the target area and distribution of V2X messages in the target area. How the V2X messages are delivered downlink in the target distribution area is not addressed by this implementation.

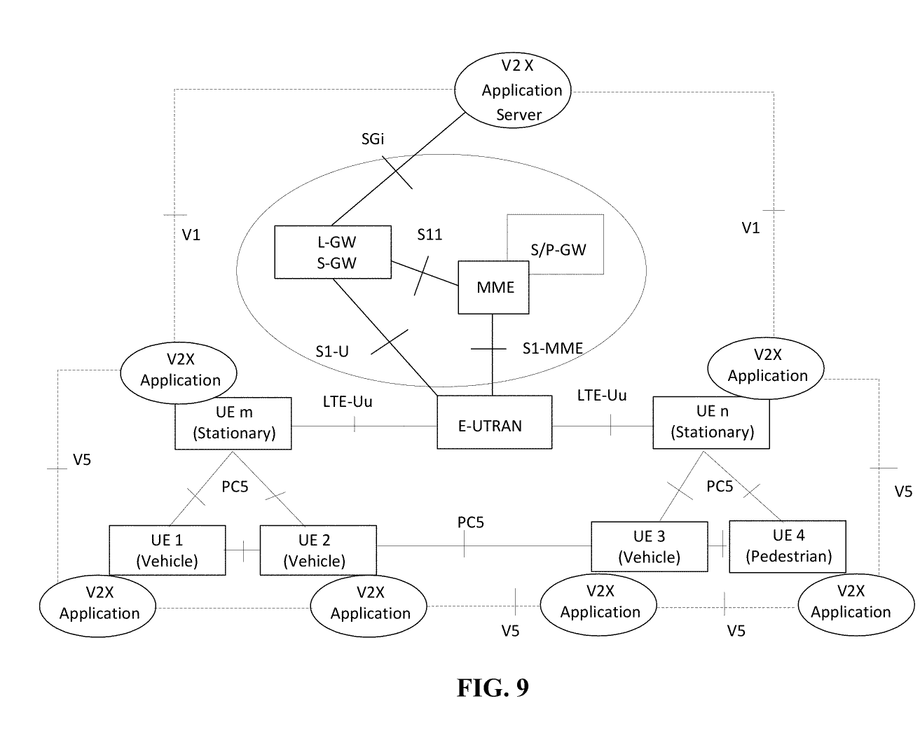

FIG. 9 shows an exemplary architecture model for V2X message transmission/reception on uplink using UE Type RSU with LTE-Uu and PC5. For SIPTO@LN, stand-alone GW architecture (with S-GW and L-GW collocated) is illustrated. However, SIPTO@LN with L-GW function collocated with the eNB is not precluded. In some implementations, the V2X Application Server in FIG. 8 can be considered as a V2X Service Layer.

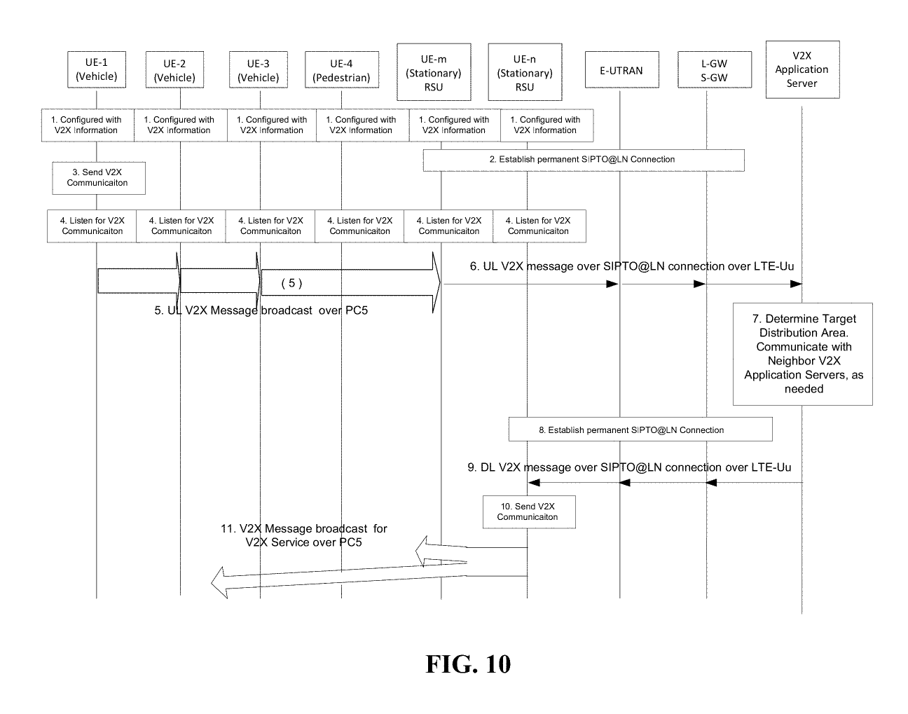

FIG. 10 shows an exemplary implementation of V2X message transmission/reception on uplink for V2X Services using RSU with PC5 and LTE-Uu. The UEs and the RSUs are configured with information for one-to-all ProSe Direct Communication or obtain such information via authorization mechanisms as proposed, for example, in TR. The RSUs establish permanent SIPTO@LN connection with L-GWs in operator network. V2X UEs and RSUs receive V2X messages using PC5 one-to-all ProSe Direct Communication. V2X messages that cannot be processed by the V2X Application(s) locally in the RSU(s) for downlink distribution are routed to the V2X Application Server in the operator network over permanent SIPTO@LN connection over LTE-Uu.

As illustrated in FIG. 10, the RSU is implemented as a stationary UE-m and hosts V2X Application. The RSU has permanent SIPTO@LN connection with E-UTRAN over LTE-Uu. UE-1 sends V2X message using one-to-all ProSe Direct Communication which is received by UE-2, by UE3 and by the RSU as in step-5. UE-4, however, does not receive the V2X message sent by UE-1 e.g. due to not being in the reliable PC5 communication range of UE-1. V2X Application(s) at the RSU(s) determines that V2X message cannot be processed locally for downlink distribution. The RSU routes the V2X message to the V2X Application Server in operator network over permanent SIPTO@LN connection over LTE-Uu as in Step-6. The V2X Application Server in operator network processes the message to determine the target area and the size of the area where the V2X message needs to be distributed. Though not illustrated in FIG. 9, the V2X Application Server may coordinate and communicate with other V2X Application Servers for the determination of the target area and distribution of V2X messages in the target area as in step-7. How the V2X messages are delivered downlink in the target distribution area is not addressed by this implementation. For illustrative purposes, steps 8-11 show downlink distribution of V2X messages using the implementation above, “V2X message transmission/reception on downlink using UE Type RSU with LTE-Uu and PC5” over permanent SIPTO@LN connections with UE type RSUs.

The following procedural summaries are made in relation to the procedures as shown in FIG. 10.

Step 1. The UEs and the RSUs are configured with information for one-to-all ProSe Direct Communication or obtain such information via authorization mechanisms.

Step 2. The RSUs establish permanent SIPTO@LN PDN connection with L-GWs in operator network.

Step 3. UE-1 accesses radio resources for V2X transmission.

Step 4. All UEs, including UE-m (UE type RSU) listen on V2X resources over PC5 for direct reception.

Step 5. UE-1 transmits a V2X message which is received by UE-2, UE-3 and by UE-m (RSU). UE-4 and UE-n, however, do not receive the V2X message sent by UE-1 due to not being in the reliable PC5 communication range of UE-1.

Step 6. V2X Application(s) at the RSU(s) determines that V2X message cannot be processed locally for downlink distribution. The RSU routes the V2X message to the V2X Application Server in operator network over permanent SIPTO@LN connection over LTE-Uu.

Step 7. The V2X Application Server in operator network processes the message to determine the target area and the size of the area where the V2X message needs to be distributed. Though not illustrated, the V2X Application Server may coordinate and communicate with other V2X Application Servers for the determination of the target area and distribution of V2X messages in the target area.

Steps 8-11. How the V2X messages are delivered downlink in the target distribution area is not addressed by this implementation. Steps 8-11 show the method of distribution of downlink messages is the implementation discussed for V2X message transmission/reception on downlink using UE Type RSU with LTE-Uu and PC5. In some implementations, Step 8 may be omitted.

V2X message transmission/reception on the uplink using UE type RSU with SIPTO@LN on LTE-Uu and PC5 one-to-all broadcast provides a reliable method that addresses V2X message transmission/reception requirements in TS 22.185 without requiring additional standardization work. With permanent SIPTO@LN PDN connections with stationary UE type RSUs there are no mobility issues. Since individual V2X UE identity is not carried over LTE-Uu to E-UTRAN, there are no privacy issues also with this implementation. This implementation, therefore, can be used as one of the bases for normative work.

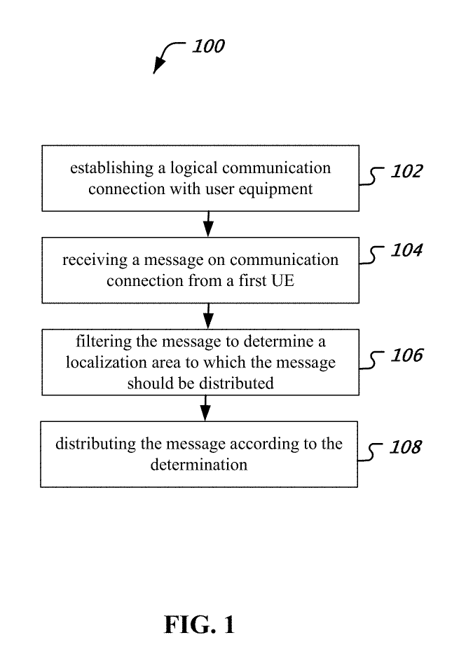

FIG. 1 is a flowchart depiction of a method 100 of wireless communication. The method 100 may be performed by a network-side server in a wireless communications network.

At 102, a logical communication connection is established with UEs in vehicles.

At 104, a message is received on the logical connection from a first UE. This message may be a V2X message. For example, this message may be received on an uplink channel at a eNodeB of an LTE network. In some embodiments, the message may be received on an uplink channel by a road-side unit of an LTE network. In some embodiments, the message may be received via an SIPTO connection or a PC5 interface. This message may have been transferred from a second UE to the first UE prior to being sent to the network.

At 106, the message is filtered to determine a localization area to which the message should be distributed. In some embodiments, the filtering at 106 may be performed at an RSU. Alternatively, or additionally, in some embodiments, the filtering may be performed at an V2X application server.

At 108, the message is distributed according to the determination to UEs in the localization area or infrastructure equipment such as RSUs within the localization area using a permanently established SIPTO connection with the infrastructure equipment.

FIG. 2 is a block diagram depiction of a wireless communication system 200. The system includes: a module 202 that establishes a logical communication connection with a vehicle; a module 204 that receives a message on communication connection from the vehicle; a module 206 that filters the message to determine a localization area to which the message should be distributed; and a module 208 that distributes the message according to the determination to infrastructure equipment in the localization area via a permanently established selected internet protocol traffic offload (SIPTO) connection with the infrastructure equipment. These modules may further be configured to implement various techniques described in this document.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is what is described and illustrated, including:

1. A method of wireless communication, implemented at network-side of a wireless communication network, comprising:
establishing logical communication connections with user equipment (UEs) in vehicles;
receiving a message on a first logical communication connection from a first UE;
filtering the message to determine a localization area to which the message should be distributed; and
distributing the message according to the determination to the UEs in the localization area via a permanently established selected internet protocol traffic offload (SIPTO) connection with the UEs.

2. The method of claim 1, wherein receiving the message comprises receiving the message on an uplink channel at an eNodeB of a long term evolution (LTE) network.

3. The method of claim 1, wherein receiving the message comprises receiving the message on an uplink channel at a road-side unit (RSU) of a long term evolution (LTE) network.

4. The method of claim 1, wherein receiving the message comprises receiving the message via the SIPTO connection or PC5 interface.

5. The method of claim 1, wherein the message is originally transferred from a second UE to the first UE over PC5 interface before the receiving of the message.

6. The method of claim 5, wherein the first UE is equipped in the a vehicle and the second UE is located at a road-side unit (RSU).

7. The method of claim 5, wherein distributing the message includes distributing the message to the first UE.

8. The method of claim 1, wherein the filtering the message is performed at a RSU or a V2X application server.

9. A wireless communication system for providing operational support to vehicular data reception and transmission, comprising:
a module that establishes logical communication connections with user equipment (UEs) in vehicles;
a module that receives a message on a first logical communication connection from a first UE;
a module that filters the message to determine a localization area to which the message should be distributed; and
a module that distributes the message according to the UEs in the localization area via a permanently established selected internet protocol traffic offload (SIPTO) connection with the UEs.

10. The system of claim 9, wherein the module for receiving includes an eNodeB of a long term evolution (LTE) network.

11. The system of claim 9, wherein the module for receiving the message comprises a road-side unit (RSU) of a long term evolution (LTE) network.

12. The system of claim 9, wherein the module for receiving the message operates to receive the message via the SIPTO connection or PC5 interface.

13. The system of claim 9, wherein the message is originally transferred from a second UE to the first UE over PC5 interface before the receiving of the message.

14. The system of claim 13, wherein the first UE is equipped in the a vehicle and the second UE is located at a road-side unit (RSU).

15. The system of claim 13, wherein the module that distributes the message operates to distribute the message to the first UE.

16. The system of claim 9, wherein the filtering the message is performed at an RSU or a V2X application server.

17. A wireless communication apparatus comprising a memory and a processor, wherein the memory stores computer code and the processor reads the code from the memory and implements a wireless communication method, the code comprising:
code for establishing a logical communication connection with a user equipment (UE) in a vehicle;
code for receiving a message on the logical communication connection from the UE;
code for filtering the message to determine a localization area to which the message should be distributed; and
code for distributing the message according to the determination to other UEs in the localization area via a permanently established selected internet protocol traffic offload (SIPTO) connection with the other UEs.

18. The apparatus of claim 17, wherein the code for receiving the message comprises code for receiving the message on an uplink channel at an eNodeB of a long term evolution (LTE) network.

19. The apparatus of claim 17, wherein the code for receiving the message comprises code for receiving the message on an uplink channel at a road-side unit (RSU) of a long term evolution (LTE) network.
